(19) United States
(12) Patent Application Publication
(10) Pub. No.: US 2014/0108522 A1
(43) Pub. Date: Apr. 17, 2014

(54) Method and System for Computer Implemented Social Networking and Searching

(71) Applicant: Michael Gersh, South Orange, NJ (US)

(72) Inventor: Michael Gersh, South Orange, NJ (US)

(21) Appl. No.: 13/649,236

(22) Filed: Oct. 11, 2012

(51) Int. Cl. G06F 15/16

(52) U.S. Cl. 709/204

(57) ABSTRACT

A computer-implemented dating service employs a selectively programmed searching processor that includes a hierarchical calendar availability protocol as key search criteria in ascertaining responsive qualified candidates. System implementation is preferably cell phone and/or web portal based communications with selection processing and data storage accomplished remotely.

### BACKGROUND

Traditional on-line personals (“dating”) sites are extremely inefficient. They generally require an individual to conduct a search of prospective dates from a pool of individuals with no regard to those individuals' availability for an actual date, let alone whether the individuals are active users of the service. Among the search results, an individual then needs to initiate contact with another user in whom he or she is interested and hopes for a reply. If a conversation develops and the two individuals would like to meet, they then need to coordinate a mutually convenient time and place. When dates from current on-line personals don't go well, the considerable effort involved in securing a bad date contributes to a generally dissatisfying experience.

This invention makes the process of securing an on-line date more efficient. With less time and effort involved in coordinating a date, even a bad date becomes a less frustrating experience. Stated differently, a system and service that simplifies the dating process will make dating more enjoyable, removing the frustration that encounters current matchmaking efforts, and increasing the chances that the individual will meet his or her goal in using the service.

### BRIEF SUMMARY OF THE INVENTION

Traditional on-line personals (“dating”) web sites and mobile applications allow a user to search for a prospective date based on criteria, including demographic information (such as age, gender), background (such as marital status, children), and interests (such as bowling or hiking). Given that the intended purpose of these applications is getting two individuals to meet for a date, the search algorithms are lacking the most important criteria—schedule availability. This invention, in one embodiment, adds a mini-calendar to a user's online profile and includes schedule availability, taken in conjunction with a select and properly weighted portfolio of dating factors, including one or more of demographics, background and interests, in the search algorithm. The addition of a calendar to the search criteria in conjunction with the properly balanced dating function set provides search results with a significantly greater likelihood of resulting in a date, because the candidates in the results are available at the same times as the searcher.

There are several advantages to a search based on calendar availability. For one, a responsive candidate is an individual that is available for that time slot, removing candidates having incompatible schedules which often are a principal basis for dating failures. Second, a simply arranged single date on a confirmed calendar day and time involves little emotional investment. While potential for success may be good, this simplicity also lowers the cost of failure.

Utilizing the calendar, and an optional collection of preferences in the profile, this invention may further arrange a listing of responsive candidates that match on calendar availability and are ranked in accordance with stored preferences for a responsive candidate.

To increase success, the system may optionally include a database detailing specific restaurants and bars in various neighborhoods within the domain of the service. Ads relating to select restaurants or bars may be displayed that correspond to the venue of the search. The system will generate a simple invitation for a generic activity such as “a drink” or “dinner”.

Further, after the invitation is delivered, the recipient can accept (or decline) the date with a single click or tap, thus avoiding any awkward or uncomfortable “excuses” in addressing the invitation. In accordance with those varying features, the invention provides a more efficient way to coordinate a date than do traditional dating sites.

### BRIEF DESCRIPTION OF THE DRAWINGS

FIG. 1 depicts a flowchart of the process a user executes to search for a prospective date, invite somebody to a date, and have that invitation be accepted.

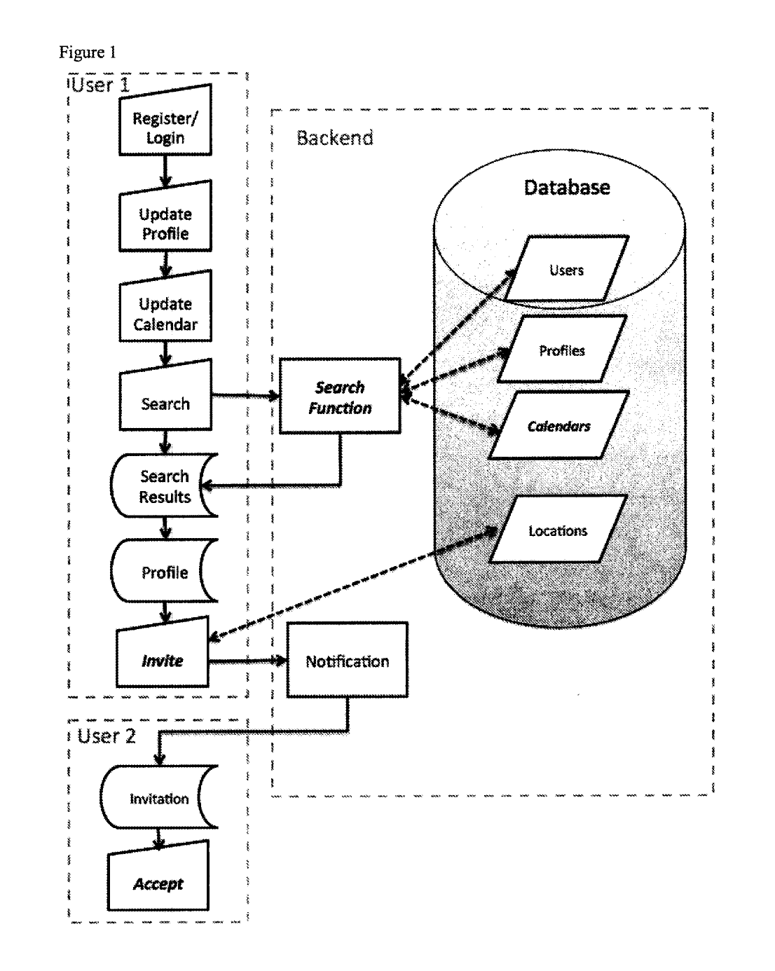

FIG. 2 illustrates a website implementation of the calendar portion of one's profile.

FIG. 3 presents a mobile application implementation of the calendar portion of one's profile.

FIG. 4 presents a website implementation of the demographic and interests portion of one's profile.

FIG. 5 presents a mobile application implementation of the interface to edit the demographic and interests portion of one's profile.

FIG. 6 presents a website implementation showing multiple search results together.

FIG. 7 presents a mobile application implementation showing search results one at a time.

FIG. 8 presents a website implementation showing the process for one individual to invite another individual.

FIG. 9 presents a mobile application implementation show the process for one individual to invite another individual.

FIG. 10 presents a website implementation showing the process for one individual to accept a date invitation from another individual.

FIG. 11 presents a mobile application implementation showing the process for one individual to accept a date invitation from another individual.

### DETAILED DESCRIPTION AND BEST MODE OF IMPLEMENTATION

The invention is for a service that runs on a website, mobile application, or an application running on any multi-user, networked platform.

Prospective users may register for the service with an email address, phone number, or other unique identifier, and a password.

Once a user registers for the service they are able to log in to the service at the time they register or any time subsequently.

A user will fill out a profile consisting of demographic and personal information, possibly including, but not limited to, age, gender, ethnicity, marital status, has children, wants children, religion, education, drinking frequency, smoking frequency, and hobbies.

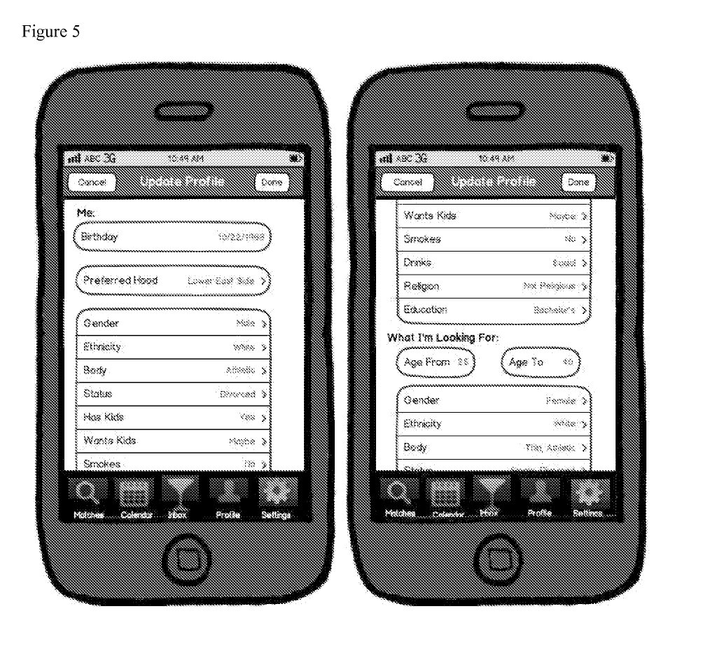

The user interface includes a form for entering information regarding the attributes of a potential date. Specifically, at FIG. 5, a user's profile data form allows entry of demographic and personal information for the type of person they are interested in dating, possibly including, but not limited to, the same information listed above.

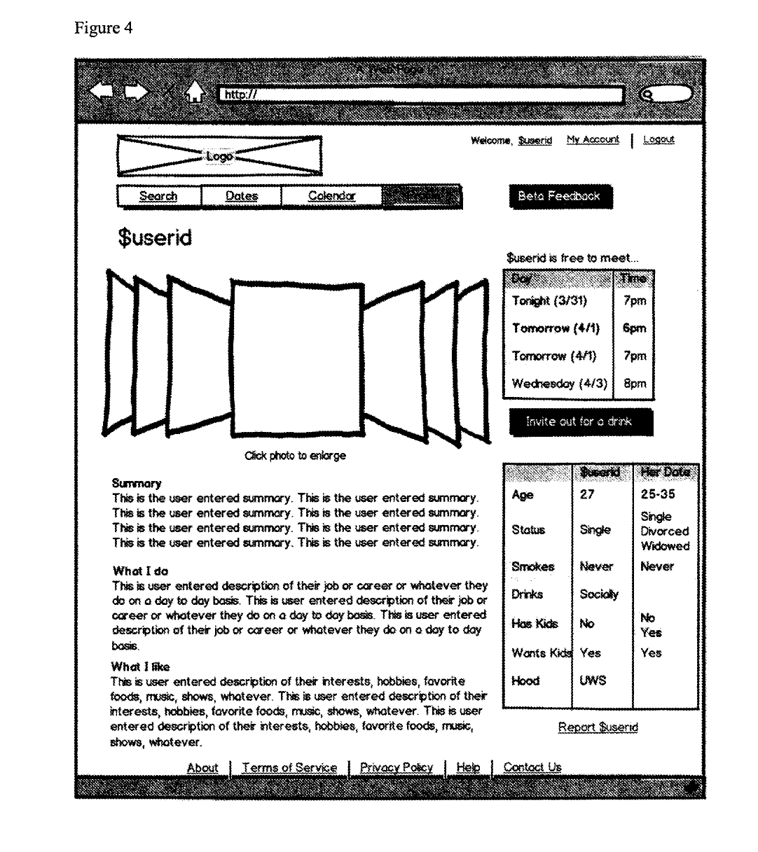

A user's profile, as shown in FIGS. 4 and 5, will include a field for the user to list preferred neighborhoods. Other information can be optionally collected, including preferred venues and activities for that location or for select cities.

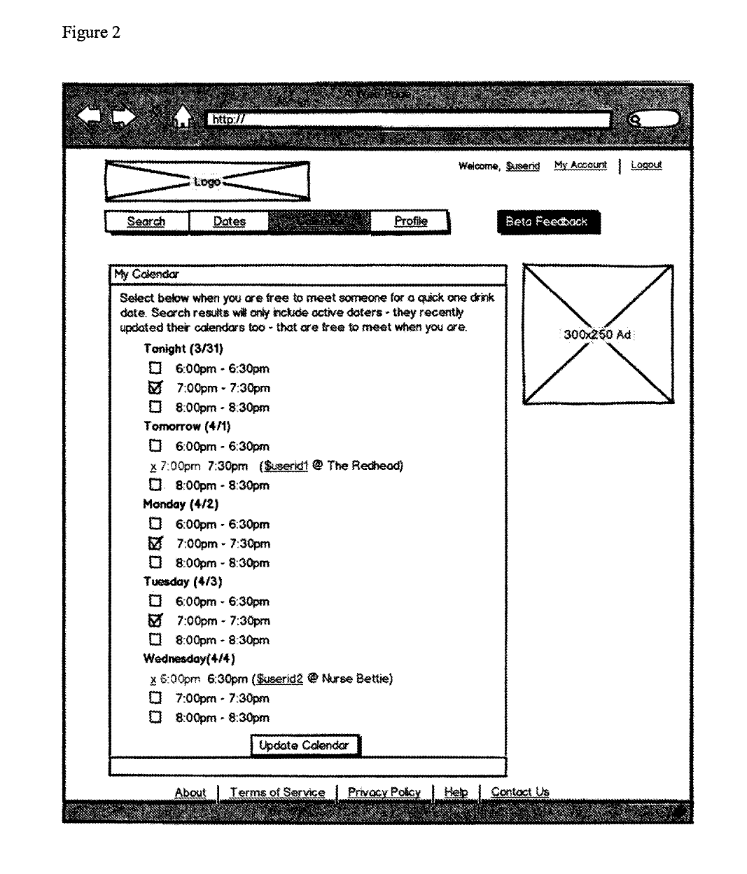

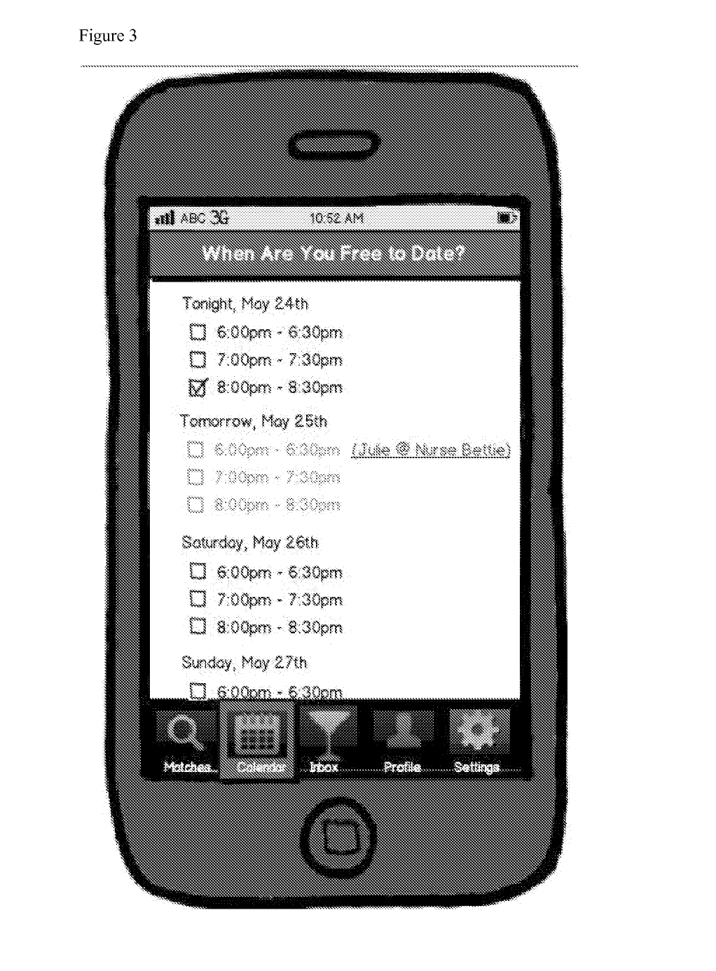

A user will create and maintain a calendar associated with their profile that documents what calendar days and times they are available to go out on a date. The calendar will list specific days starting with “today's” date and specific time slots for each day, as depicted in FIGS. 2 and 3, for short intervals (e.g., 3-5 days). As time progresses throughout the day, the offered time slots will roll over and bridge into the next day, offering a progressively changing window of times within the specified date interval. The system may apply a “learning” algorithm, changing the roll sequence based on a past user patterns.

In a preferred arrangement, the service will provide the ability for an individual to search for prospective dates. Based on stated criteria, the system will rank candidates and individuals having availability by order of responsiveness.

The search algorithm will take into consideration the searching user's demographics and interests, as well as their calendar availability, and return search results that only include individuals that have a least one shared mutual day-and-time slot within the date interval. To drive time-consistent results, the search criteria can be set with “available” open data slots as a primary filter, and with a series of secondary screening inquiries used for ranking responsive returns. Secondary screening can be selected from a host of choices including “age,” “drinking habits,” “gender” or “children.” Of course, demographic data and related entries can be set as filters or “preferences.” The distinction is that filters will exclude, while a stored preference will adjust the position of a return within a ranking. Responses having the highest preferences in the ranking algorithm will be given the most weight in returning “date” options.

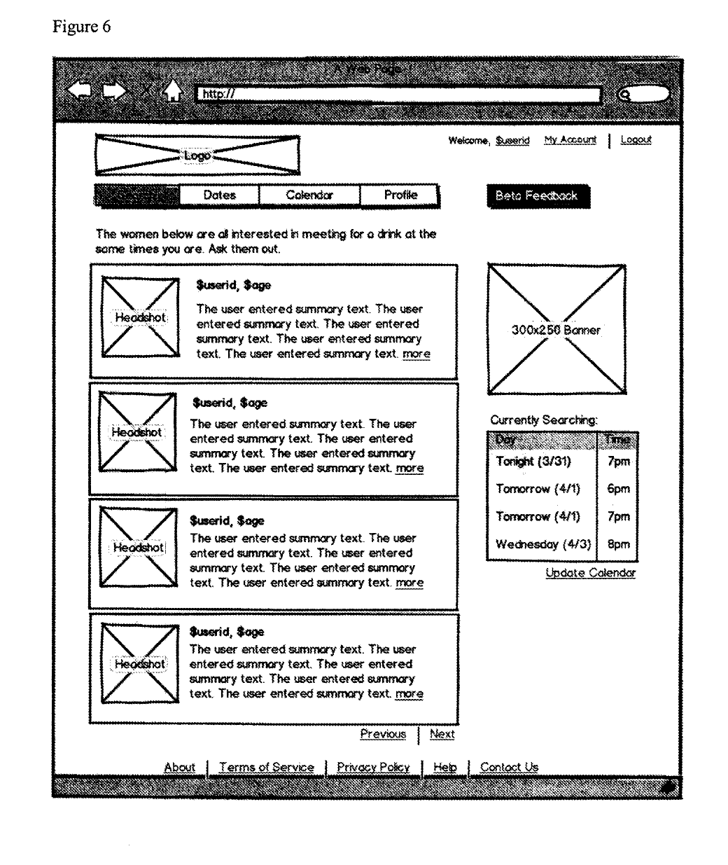

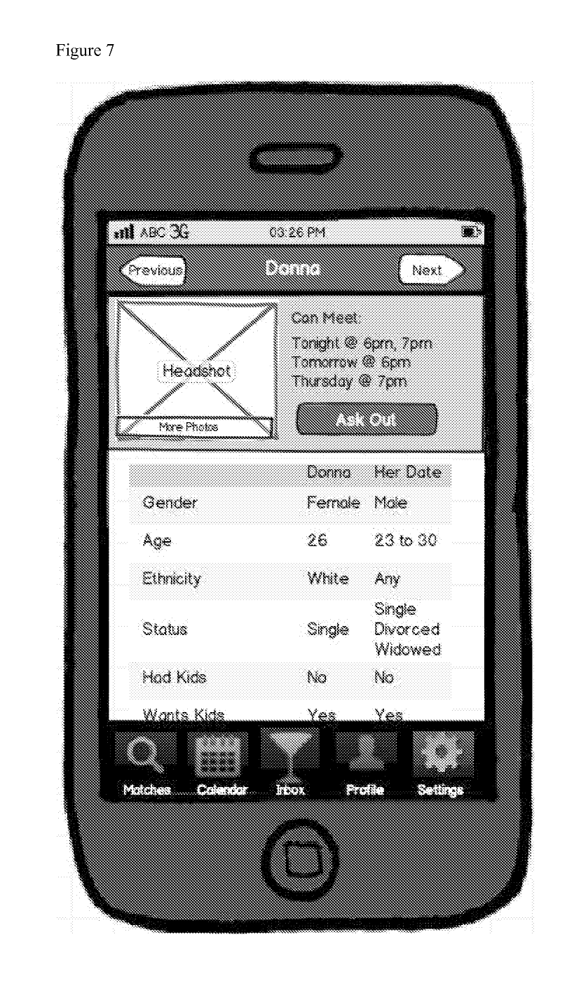

Multiple search results may be presented at the same time and the user may click through one result to see a specific individual's profile. As shown in FIGS. 6 and 7, search results may also be presented one at a time by showing an individual's profile directly.

The profile of an individual will include a prominent button or link directing the viewer of the profile to invite or ask out on a date the individual whose profile is being viewed. Clicking on this link or button will bring up a form that allows the user to invite the user depicted in the profile. This is shown in FIG. 4 and FIG. 7.

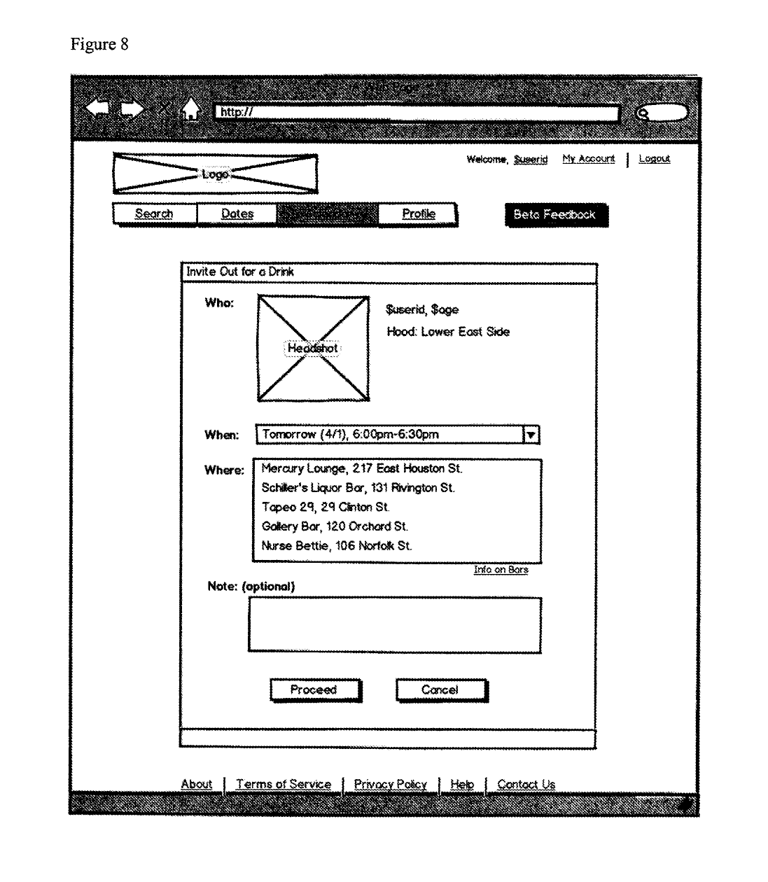

The invitation page will prompt the user to select a time for the date from a list of times for which both the person inviting and the intended recipient are available, as per their calendars. (FIG. 8, 9)

The service will maintain a database storing specific bars, restaurants, cafés and other potential date locations. The neighborhood, such as “Upper East Side,” will be stored with each location

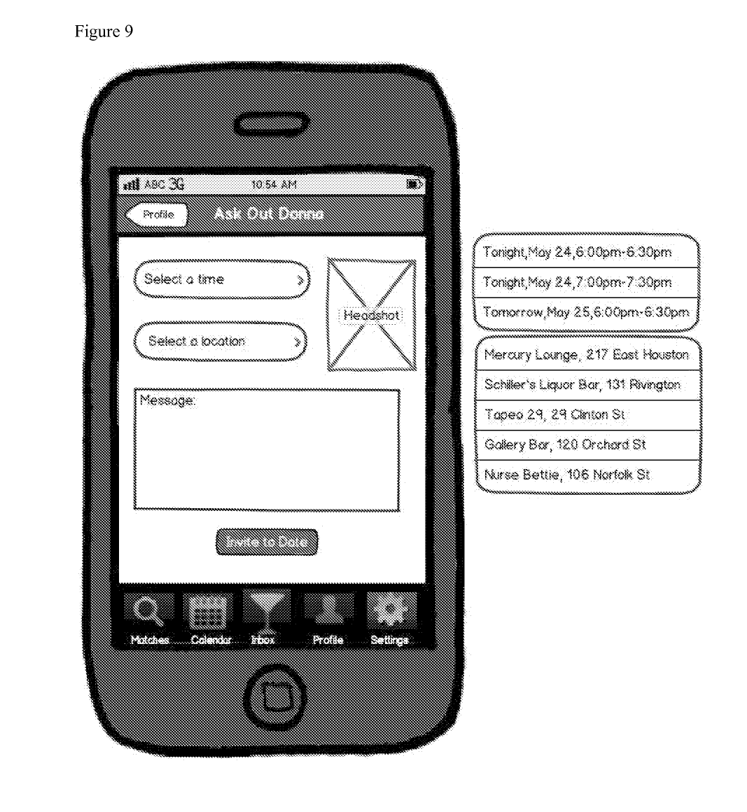

In one embodiment, the invitation page will prompt the user to select a location for the date from a list of destinations that are in the intended recipient's preferred neighborhood for dating. This is shown in FIGS. 8 and 9. Alternately, choices of venue may be prepackaged with special deals and rates, again targeting a selection that meets one or more preference entered by the responsive candidates.

Once a choice is made, the invitation page will include a button or link to send out the invitation. See FIGS. 8 and 9. Clicking on the button will result in a notification being sent to the intended recipient by a method such as, but not limited to, electronic email, SMS text message, app push notification, message board within the service, or other.

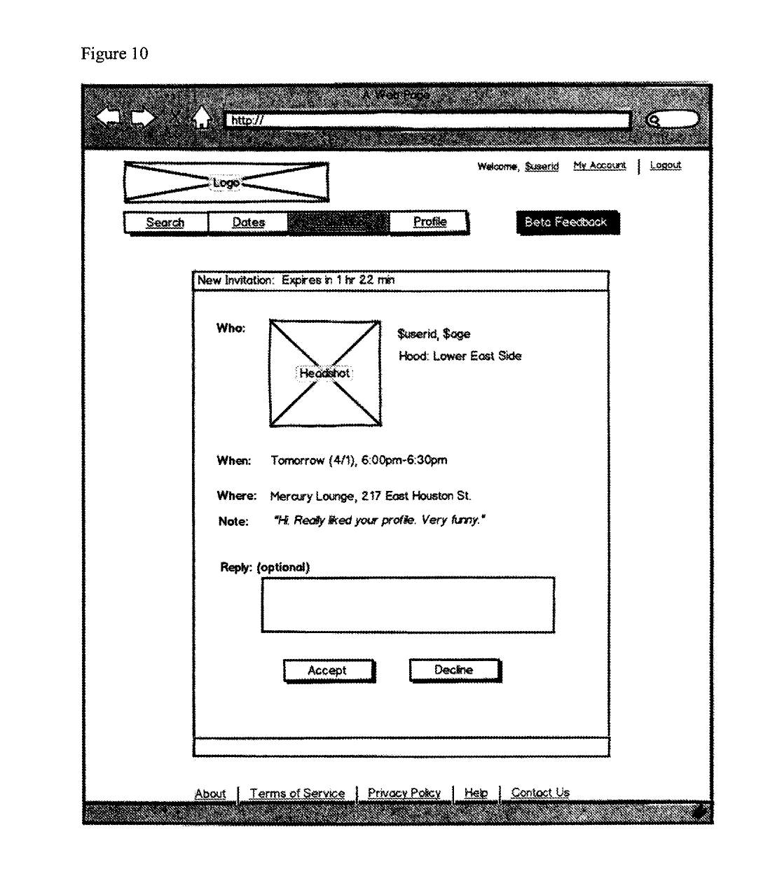

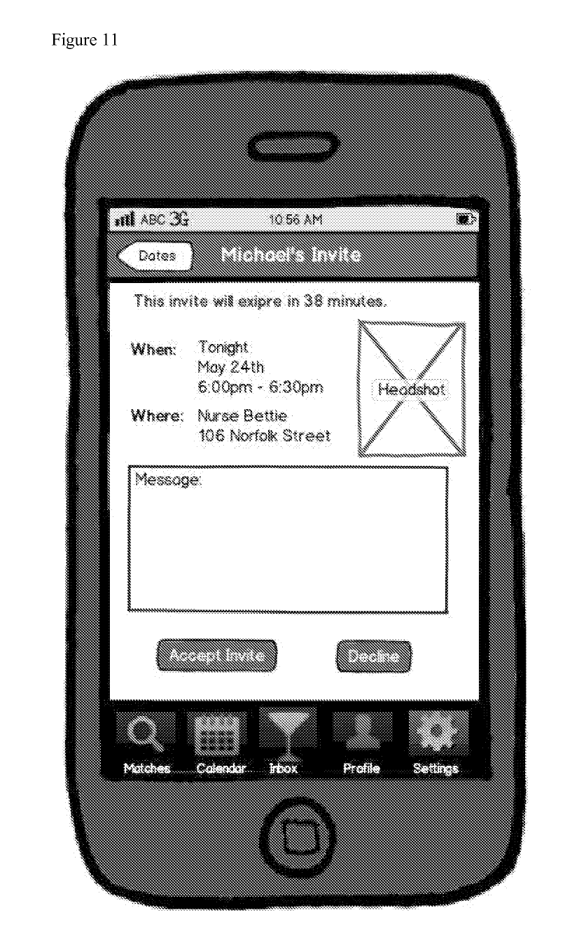

A properly delivered invitation to the responsive candidate will direct them to a page or screen where they may accept the date by simply clicking on a single button or link. This is shown in FIGS. 10 and 11. Again, in an alternate arrangement the responding candidate may send a return message, altering the venue or making other adjustments, or a rain check.

The ranking of preferences can be user defined or accomplished by system defaults. If defaults are used, a stored selection of demographically weighted preferences can be the initial default value.

In addition to filters, preferences and system weightings, further search criteria is based on “unilateral” or “bilateral” searches. A unilateral search seeks a match solely predicated on preferences of the searcher and the characteristics of recipients and ignores the preferences of the candidate entries in the recipient database and the characteristics of the searcher. A bilateral search, in contrast, analyzes the preferences of the candidate entries residing in the database in addition to the stored preferences of the searcher in assessing the proximity of the “match,” so that both parties for a “date” have influenced the selection/hit.

Finally, the search engine will rely on hidden data or stored and analyzed experiences. For example, a search result repeatedly offered but not selected will be, e.g., filtered out. Similarly, if a searcher selects a responsive candidate, that individual will be dropped from the results in future searches.

One advantage of the search calendar, particularly given the short scheduling time slots or windows, is that by necessity the participants must be “active” users of the system. The level of activity required by the fixed and/or limited scheduling window will amplify the opportunity for those truly seeking engaging social contact.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

1. A communication server for facilitating social dating, comprising:
a. a communication portal for receiving plural requests and for distributing responses to said requests wherein each request is directed to seeking individuals for social contact and interpersonal interaction; and
b. a program-controlled data processor for receiving said requests and implementing a selectively configured searching algorithm to provide responses to said requests where said algorithm includes hierarchical application of calendar availability as a key search criteria in organizing and outputting said responses.

2. The server of claim 1 wherein said requests originate from one or more smart cell phones and said responses are formatted for delivery to one or more smart cell phones.

3. The server of claim 1 wherein said requests originate from one or more desktop or laptop computers and said responses are formatted for delivery to one or more desktop or laptop computers.

4. The server of claim 1 wherein said requests originate with a portable communications device and said responses are formatted for delivery to a portable communication device.

5. A communication device comprising a stored program for implementing a search request for a social engagement that includes a selected day and time within a specific interval of time, and is capable of receiving a response from a remotely located computer, wherein said response includes information regarding one or more candidates having calendar availability that matches the day and time of said request.

6. The device of claim 5 wherein said response is further based on a search algorithm implemented on said remote computer to rank said response based on a plurality of stored preferences.

7. The device of claim 5 wherein said communication device is web-based.

8. The device of claim 5 wherein said device is selected from a desktop computer, video game console, laptop computer, cell phone and tablet computer.
